(19) United States
(12) Patent Application Publication
(10) Pub. No.: US 2016/0275180 A1
(43) Pub. Date: Sep. 22, 2016

(54) SYSTEM AND METHOD FOR STORING AND SEARCHING DATA EXTRACTED FROM TEXT DOCUMENTS

(71) Applicant: ABBYY InfoPoisk LLC, Moscow (RU)

(72) Inventor: Stepan Matskevich, Moscow Region (RU)

(21) Appl. No.: 14/717,647

(22) Filed: May 20, 2015

(30) Foreign Application Priority Data
Mar. 19, 2015 (RU) 2015109666

(51) Int. Cl. G06F 17/30; G06F 17/24

(52) U.S. Cl. CPC G06F 17/30684; G06F 17/30011; G06F 17/30613; G06F 17/241

(57) ABSTRACT

Disclosed are system and method for storing, searching and updating extracted data for natural language processing of text. An example method comprises extracting at least one first information object from a text document; generating one or more subject-predicate-object triplets for the first information object; accessing a storage of extracted data that contains a RDF graph comprising a plurality of subject-predicate-object triplets for a plurality of different information objects; searching the storage of extracted data for a second information object related to the first information object, wherein searching includes selecting and searching at least one of three types of N-gram identifier tables containing one of a double, a triple and a quad search indices associated with at least two of a subject, a predicate, an object and a document; when at least one second information object related to the first information object is found, wherein two objects are related when said two objects have at least one of a subject, a predicate and an object in common, updating the storage of extracted data by adding the at least one subject-predicate-object triplet of the first information object to the master RDF graph and associating the first and second information objects with each other.

### CROSS REFERENCE TO RELATED APPLICATIONS

This application claims the benefit of priority to Russian Patent Application No. 2015109666, filed Mar. 19, 2015; disclosure of which is hereby incorporated by reference in its entirety.

### TECHNICAL FIELD

The present disclosure relates generally to the field of natural language processing, and, in particular, to systems, methods and computer programs for storing and searching data extracted from different natural language text documents.

### BACKGROUND

The growth in popularity of Internet has resulted in availability of large volumes of electronic text documents online, such as e-books, articles, emails, chats, etc. Automated processing of these text documents typically requires use of Natural Language Processing (NLP) technologies. Essential elements of such technologies, including methods and the applications created on the basis thereof, are systems for analysis of texts in natural language, linguistic descriptions, systems of extraction of information and ontologies as models of subject fields.

The electronic text documents are generally unstructured, and, therefore, the task of automatic extraction and structuring of the information contained therein is rather challenging. These processes include identification of various information objects in the text documents and identification of relations among them and entities in the real world, for subsequent use in the construction of formal models of subject fields in various applications.

Generally, extracted information may be stored in form of Resource Description Framework (RDF) graphs that are conformed to different ontologies. These RDF graphs of information may be very complex due to large number of ontological concepts, instances and relations contained therein. Yet, these RDF graphs must be easily searched during natural language processing of text documents by a computer system. Therefore, there is a need for efficient techniques for extraction, storage and search of information from text documents.

### SUMMARY

Example aspects are described herein in the context of a system and method for storing, searching and updating data extracted from text documents.

In one aspect, an example method includes extracting at least one first information object from a text document; generating one or more subject-predicate-object triplets for the first information object; accessing a storage of data that contains a RDF graph comprising a plurality of subject-predicate-object triplets for a plurality of different information objects; searching the storage of data extracted from text document for a second information object related to the first information object, wherein searching includes selecting and searching at least one of three types of N-gram identifier tables containing one of a double, a triple and a quad search indices associated with at least two of a subject, a predicate, an object and a document; when at least one second information object related to the first information object is found, wherein two objects are related when said two objects have at least one of a subject, a predicate and an object in common, updating the storage of extracted data by adding the at least one subject-predicate-object triplet of the first information object to the master RDF graph and associating the first and second information objects with each other.

In one example aspect, the selection of a search index is based on the type of searched object and its features.

In one example aspect, the lines of each N-gram identifier table are sorted lexicographically.

In one example aspect, the double index includes a table with two columns that stores object (o) and document (d) identifiers.

In one example aspect, the triple index includes one or more tables with three columns that store one or more permutations of subject (s), predicate (p) and object (o) identifiers.

In one example aspect, the quad index includes a table with four columns that stores document (d), subject (s), predicate (p) and object (o) Identifiers.

In one example aspect, wherein when at least one second information object related to the same object in real world as the first information object is found in the storage of extracted data, updating the storage further including: determining subject identifier of the second information object in the storage; and adding one or more new features of the first information object to the features of the subject identifier of the second information object in the storage. In one example aspect, wherein when at least one second information object related to the same object in real world as the first information object is not found in the storage of extracted data, updating the storage further including: assigning a new subject identifier to the first information object; and adding one or more new features of the first information object to the three types of N-gram identifier tables.

In one example aspect, the method further comprising generating an annotation for the first information object that indicates a relationship of the annotated first information object to the text document; marking in the text document the annotated first information object; and storing in the storage of extracted data the annotation and at least a portion of the text document containing the annotated first information object.

In one aspect, a system for storing, searching and updating extracted data, the system comprising: a storage of extracted data containing a RDF graph comprising a plurality of subject-predicate-object triplets for a plurality of different information objects; a hardware processor coupled to the storage, the processor being configured to: extract at least one first information object from a text document; generate one or more subject-predicate-object triplets for the first information object; search the storage of extracted data for a second information object related to the same object in real world as the first information object, wherein two information objects are related when said two information objects have at least the subject parameter in common, and wherein searching includes selecting and searching at least one of three types of N-gram identifier tables containing one of a double, a triple and a quad search indices, wherein each search index is based on at least two parameters selected from a subject, a predicate, an object and a document; when at least one second information object related to the first information object is found, update the storage of extracted data by adding the at least one subject-predicate-object triplet of the first information object to the RDF graph and updating at least one of three types of N-gram identifier tables with information the first and second information objects with each other.

In one aspect, an example computer program product, stored on a non-transitory computer-readable storage medium, comprising computer-executable instructions for storing, searching and updating extracted data, comprising instructions for extracting at least one first information object from a text document; generating one or more subject-predicate-object triplets for the first information object; accessing a storage of extracted data that contains a RDF graph comprising a plurality of subject-predicate-object triplets for a plurality of different information objects; searching the storage of extracted data for a second information object related to the first information object, wherein searching includes selecting and searching at least one of three types of N-gram identifier tables containing one of a double, a triple and a quad search indices associated with at least two of a subject, a predicate, an object and a document; when at least one second information object related to the first information object is found, wherein two objects are related when said two objects have at least one of a subject, a predicate and an object in common, updating the storage of extracted data by adding the at least one subject-predicate-object triplet of the first information object to the master RDF graph and associating the first and second information objects with each other.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and particularly pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a general scheme for adding to the storage in accordance with one example aspect of the invention.

FIG. 2 illustrates a sequence of steps of the semantic and syntactic analysis in accordance with one example aspect of the invention.

FIG. 3 illustrates a general scheme for the information extraction process in accordance with one example aspect of the invention.

FIG. 4 illustrates an example of the application of the information extraction rules to the sentence “The president of Microsoft Bill Gates met Apple co-founder Steve Jobs at Digital Conference.” in accordance with one example aspect of the invention.

FIG. 5 illustrates an RDF graph of the sentence “The president of Microsoft Bill Gates met Apple co-founder Steve Jobs at Digital Conference.” in accordance with one example aspect of the invention

FIG. 6 illustrates a general scheme for the global identification process in accordance with one example aspect of the invention.

FIG. 7 illustrates an example of visualizing annotations in accordance with one example aspect of the invention.

FIG. 8 illustrates an example of building a triple index in accordance with one example aspect of the invention.

FIG. 9 illustrates examples of search operations in a triple index in accordance with one example aspect of the invention.

FIG. 10 illustrates an example of a complex search operation in a triple index in accordance with one example aspect of the invention.

FIG. 11 illustrates an example of a computer system that may be used to implement example aspects of the invention.

References are made to these attached drawings throughout the detailed description given below. Unless the context dictates otherwise, identical symbols in these drawings usually signify analogous components. The illustrative aspects given in the detailed description, drawings, and claims are not the only possible embodiments. Other embodiments of the invention, are possible, and other changes that do not affect the object or essence of the invention are also possible. Various aspects of the present invention, which are set forth in this description of the invention and illustrated by the drawings, may be combined, replaced, grouped, and structured to obtain a wide range of different application alternatives. They are all obviously implied in this description of the invention and are considered a part thereof.

### DETAILED DESCRIPTION

Example aspects are described herein in the context of a system and method for storing and searching information extracted from the text for use in natural language processing of text. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

### General Description of the Information Extraction Process

Disclosed is a method for organizing a data storage of information extracted from a text (or corpus of texts) written in a natural language. Before it enters the data storage, the information must be extracted from the text and represented using a special data structure that enables rapid searching of the information and also allows it to be stored compactly. Moreover, the information extraction process itself represents a complex technical task, which for the purposes of the present invention is performed using a system of production rules that are in turn applied to structures resulting from a complete semantic and syntactic analysis.

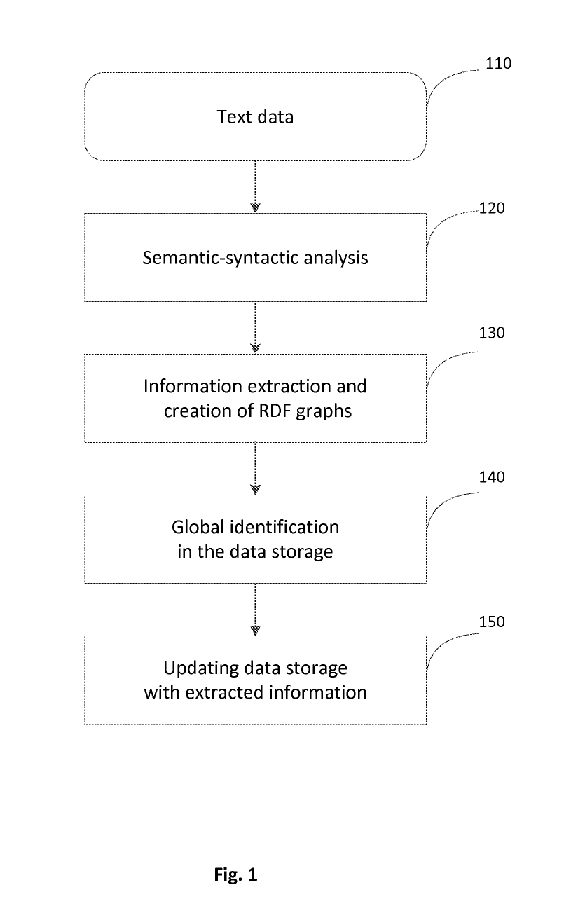

The main steps of the method being described are outlined in FIG. 1. At step 110 text data (with or without markup) is fed into the system. It is subject to semantic and syntactic analysis at step 120. A commonly owned U.S. Pat. No. 8,078,450 describes a method that includes deep syntactic and semantic analysis of natural language texts based on exhaustive linguistic descriptions. The method uses a broad range of linguistic descriptions, such as universal semantic mechanisms associated with a specific language, which allow all real complexities of the language to be reflected without simplification or artificial limits, without any danger of unmanageable growth in complexity. In addition, these analytical methods are based on principles of holistic goal-oriented recognition, i.e., hypotheses about the structure of a portion of a sentence are verified as part of checking the hypotheses about the structure of the entire sentence. That makes it possible to avoid analyzing a large set of anomalies and variations. The semantic and syntactic analysis will be described in more details below.

The results of the complete semantic and syntactic analysis are then used in the information extraction process at step 130, from which an RDF (Resource Description Framework) graph is generated. The information extraction module processes a forest of semantic and syntactic trees, one tree for each sentence of the source text. In accordance with the RDF concept, the extracted data is represented as a set of <subject, predicate, object>(<s, p, o>) triplets. The subject is some entity, or information object, that represents an object in the real world. The predicate is a certain feature that describes the subject. There are two types of predicates (properties, or features): attributes and relations. An attribute is a non-object feature with the value of a simple data type: string, integer, or Boolean value. A relation is an object feature which value is another information object that represents a different entity in the real world. An object is therefore a given predicate's value for a given subject and may be either a simple data type (integer, string, etc.) or the identifier of a different information object. There are various types of information objects, for example: Person, Location, Organization, Job Placement Confirmation etc. All RDF data extracted from text conforms to a model of the domain (the types of information objects match concepts from an appropriate ontology) within which the information extraction module is running.

To add the information extracted from documents to the data storage, global identification at step 140 may be performed. Its purpose is to join the RDF graphs of separate documents into one common graph, while merging information objects that represent the same object in the real world.

The global identification process concludes by updating the data storage of extracted information with information extracted from the new document at step 150.

We will discuss in greater detail each step of the method being described.

### Semantic and Syntactic Analysis

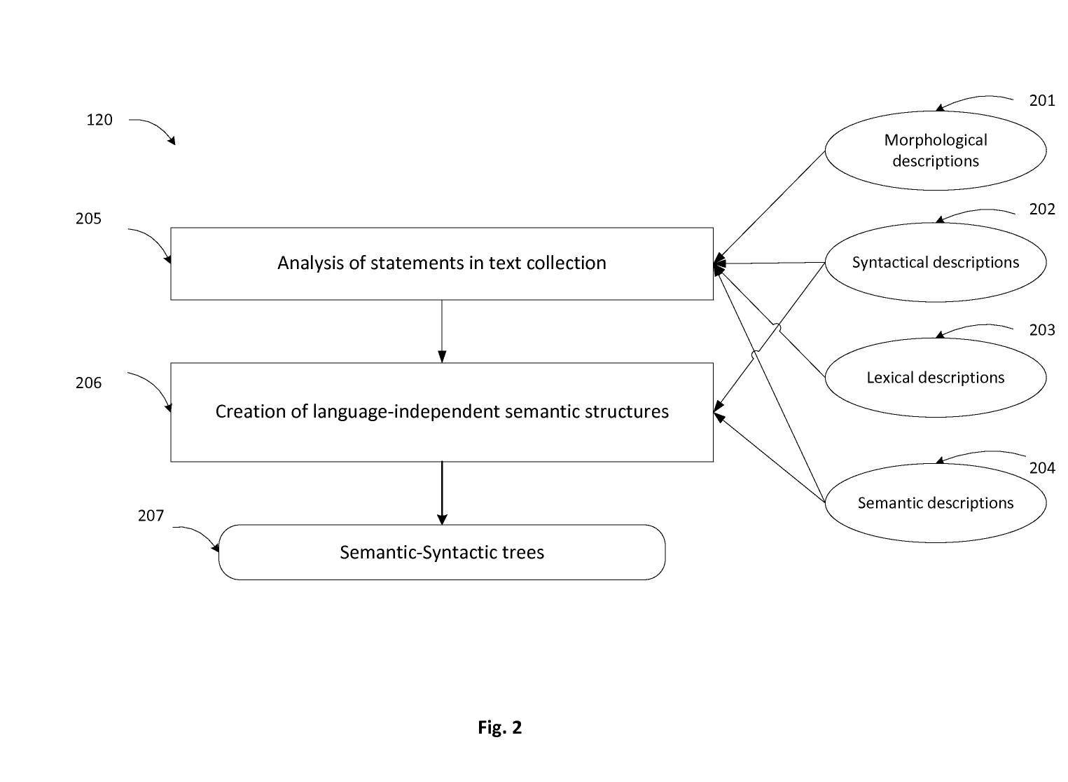

FIG. 2 illustrates the general outline of a method for deep syntactic and semantic analysis [120] of natural language texts [110], which is based on linguistic descriptions. This method is presented in detail in U.S. Pat. No. 8,078,450. The method uses a wide range of linguistic descriptions, such as universal semantic mechanisms. These analytical methods are based on principles of holistic goal-oriented recognition, i.e., hypotheses about the structure of a portion of a sentence are verified as part of checking the hypotheses about the structure of the entire sentence. This makes it possible to avoid analyzing a large number of variations.

In one example aspect, deep analysis includes lexical-morphological, syntactic, and semantic analysis of each sentence of the text corpus, resulting in construction of language-independent semantic structures in which each word of text is assigned to an appropriate semantic class (SC) in the universal Semantic Hierarchy (SH).

In one example aspect, a Semantic Hierarchy is a lexical-semantic dictionary that contains all of the language's vocabulary necessary for text analysis and synthesis. A Semantic Hierarchy is organized as a tree of subsumption relations. The tree's nodes are Semantic Classes (SC), which are universal (identical for all languages) and reflect a certain conceptual meaning, and Lexical Classes (LC), which are language-specific, being the descendants of a certain semantic class. The aggregation of all of the lexical classes of a single Semantic Class defines a semantic field: a lexical expression of the conceptual meaning of the Semantic Class. The most widespread concepts are located at the upper levels of the hierarchy.

In one example aspect, a child semantic class in the Semantic Hierarchy inherits most of the properties of its direct parent and all of its ancestor semantic classes. For example, the semantic class SUBSTANCE is a child semantic class of the class ENTITY and a parent semantic class of the classes GAS, LIQUID, METAL, WOOD_MATERIALS, etc.

The source sentences in the text/corpus [110] are subject to exhaustive semantic-syntactic analysis at step 205 with the use of linguistic descriptions of both the source language and universal semantic descriptions, which makes it possible to analyze not only the surface syntactic structure but also recognize the deep semantic structure that expresses the meaning of the statement contained in each sentence, as well as the relationships between sentences or text blocks. Linguistic descriptions may include lexical descriptions [203], morphological descriptions [201], syntactic descriptions [202] and semantic descriptions [204]. The analysis [205] includes a syntactic analysis done as a two-stage algorithm (rough syntactic analysis and precise syntactic analysis) using linguistic models and information at various levels to compute probabilities and generate a set of syntactic structures. Consequently, a semantic and syntactic structure [207], or in other words a semantic-syntactic tree is created in step 206.

In one example aspect, the semantic-syntactic analyzer's morphological model resides below the semantic hierarchy. For each language there is a list of lexemes and their paradigms. Within the semantic hierarchy each lexeme may be assigned to one or more lexical classes. A lexical class usually unites several lexemes.

In one example aspect, each node of the resulting semantic-syntactic tree is assigned to some lexical class in the semantic hierarchy, which presumes that ambiguous words are eliminated during the analysis. Each node also contains grammatical and semantic information that determines its role in the text, specifically a set of grammemes and semantemes.

In one example aspect, each edge of the semantic-syntactic tree stores the surface position (i.e. the dependent node's syntactic function, e.g. $Subject or $Object_Direct) and deep position (i.e. the dependent node's semantic role, e.g. Agent or Experiencer). The set of deep positions is universal and language independent, unlike the set of surface positions, which differs from language to language.

The semantic-syntactic tree may be independent of a specific language, making it possible to use it in various applications, such as a machine translation system. The set of information extraction rules are applied to the resulting forest of parse trees. Ontological rules are used to extract data from texts. Ontological rules are rules that define how facts are expressed in texts. A preliminary semantic-syntactic analysis of texts using the technique described makes it possible to define and use ontological rules on structured data, specifically deep (semantic) structures, taking into account the lexical, syntactic and semantic attributes extracted during initial parsing.

The information extraction system also works mainly with deep structures. This makes the rules more general and universal. However, the rule syntax also facilitates the use of the syntactic tree's surface properties, specifically because they store all the surface syntax information. In many instances the information extraction system may use the source text of the analyzed document directly, without “looking at” the semantic-syntactic tree. In particular, if the source document has been previously formatted using some system of tags, it is possible to consider this markup during information extraction (the extraction rules contain a special construct for working with tagged domains).

### Ontology

An ontology is a formal explicit description of some domain. The basic components of an ontology are concepts (or, in other words, classes), instances, and relations. An ontology's concepts represent a formally defined and named set of instances that have been generalized with respect to some feature. An example of a concept might be the set of all people, combined into the concept “Person”. Concepts in an ontology form a taxonomy, i.e. a hierarchical structure. An instance is a specific object or phenomenon of the domain in which the concept resides. For example, the instance Yury_Gagarin is included in the concept “Person”. Relations are formal descriptions between concepts, which capture the kinds of relationships that can be established between instances of these concepts. An ontology is a model of a domain, defined using a statement in the OWL DL language. An ontology is not the same as a semantic hierarchy, despite the fact that it may be bound to elements of the semantic hierarchy by referential links. Ontologies may be inherited from other ontologies. All concepts, instances, and relations belonging to a parent ontology are also considered to belong to the descendant ontology.

A relation in an ontology has what is known as cardinality, which determines the range of values that a feature can have. For example, the relation <last name> can only have one value, because a person cannot have several last names at the same time.

An approach similar to that set forth in the W3C recommendations for modeling N-ary relations is used to represent data about situations and events.

The data produced by the information extraction module automatically conforms to the domain model. On one hand, this is facilitated by the syntax of the language of the information extraction rules. On the other hand, special validation mechanisms that prevent the occurrence of ontologically incorrect data are built into the system.

### Mechanism of Information Extraction

In one example aspect, the process of information extraction is controlled by a production rule system. There are two types of rules: rules for interpreting semantic-syntactic tree fragments, and rules for identifying information objects.

The interpretation rules make it possible to define fragments of semantic-syntactic trees, which, when detected, cause certain sets of logical statements to come into effect. One rule is a production, the left side of which is a pattern for a fragment of a semantic-syntactic tree, while the right side is a set of expressions defining logical statements.

The left side of interpretation rules is a pattern for a semantic-syntactic tree (a tree pattern), which represents a claim. Its atomic elements are verifications of different properties of the semantic-syntactic tree (the presence of a particular grammeme/semanteme, membership in a lexical/semantic class, location at a certain surface/deep position, and much more).

The right side of rules contains the following types of statements:

1. Existence statements that proclaim the existence of information objects and assign unique identifiers to them.

2. Class membership statements that clarify or somehow modify the object's membership in one of the ontology's concepts. For example, an existing “Organization” object may be clarified to be a “Commercial Organization”.

3. Feature statements that specify information objects' properties. In a feature statement a set of values of an object's feature includes some particular value. In accordance with the RDF concept, it may either be another information object's identifier or a simple data type (integer, string, Boolean).

4. Annotation statements that connect information objects to parts of the original input text. Annotation coordinates are calculated from the bounds of syntactic-semantic tree nodes. Annotation can cover either a single node (i.e. a word), or a full subtree of that node.

5. Anchor statements that link information objects to parse tree nodes, which enables one to access these objects later during the extraction process. In general, one information object can be anchored to a set of nodes via a number of anchor statements.

6. Identification statements that make it possible to determine that two information objects are the same object in the real world.

7. Functional restrictions that may be placed on a group of information objects. A function that returns a Boolean value and takes as arguments a set of information object identifiers and some constants (for example, identifiers of nodes of semantic-syntactic trees) may be added to a statement receptacle.

Logical statements form what is known as a “statement receptacle” that has a number of properties:

1. Cumulative. New statements can only be added to the receptacle, not removed.

2. Self-consistent. Statements in the receptacle do not contradict one another, e.g. they do not violate conformity with the ontology (they do not change the relation's cardinality).

3. Ontological. The statement receptacle may be used at any time to construct an annotated RDF graph (an RDF graph with information on annotations) that conforms to the ontology.

4. Transactional. Statements are added to the receptacle in groups. If even one statement in a group contradicts other statements in the receptacle (or the group itself), then the addition of all of the group's statements is canceled.

Tree patterns may contain conditions that define the information objects that must be linked by anchors to the corresponding nodes of the semantic-syntactic tree in order for the rule to be triggered. These are called positive object conditions. There are also negative object conditions that, conversely, make it possible to specify which objects must not be linked to the node. Object conditions were mentioned previously in connection with statements about anchors.

When recording logical statements in the right side of rules, the nodes of a fragment of a semantic-syntactic subtree mentioned in the left side and information objects associated with positive object conditions must frequently be referenced. The ability to name individual parts of tree patterns is provided for this purpose. If a pattern is successfully associated with some fragment of a semantic-syntactic subtree, specific nodes may be accessed using the names of the pattern parts. These names, which are entered on the left side, are called variables. Variables are used on the right side of rules to create statements and in a number of instances on the left side (to create complex conditions expressing some relationship between several nodes of the tree). Variables may be plural or singular. Plural variables may associated with more than one node, while singular variables may be associated with at most one node.

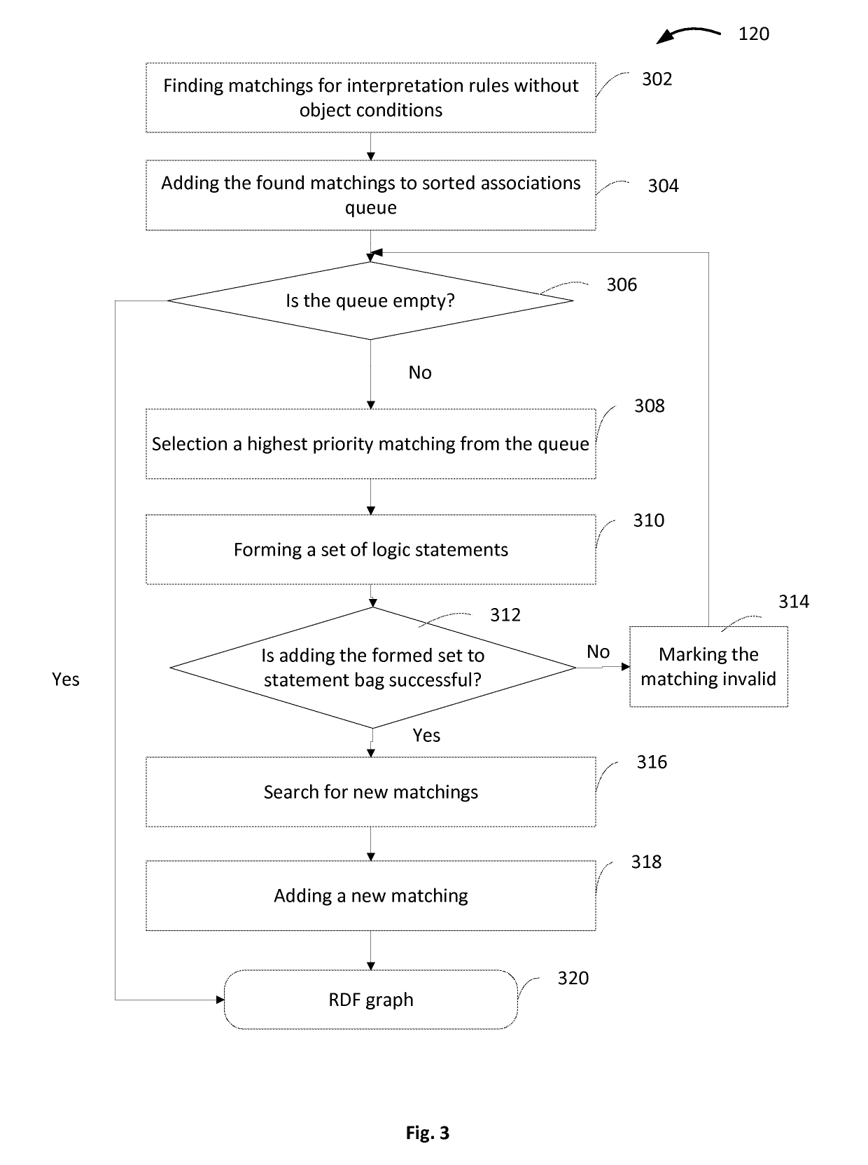

An example of the information extraction method is outlined in FIG. 3. In step 302, all of the matchings for interpretation rules without object conditions are detected. The detected matchings are then added in step 304 to a sorted queue of matchings. If the queue of matchings is empty, in step 306, then the task is done. If the queue is not empty, then the matching with the highest priority is taken, in step 308, from the queue. Then, in step 310, a set of logical statements is generated based on the right side of the corresponding rule. Then the generated set is added to the statement receptacle in step 312. If this fails, the matching is marked invalid in step 314 and a check is again performed if the queue of matchings is empty. Otherwise, if the set is added successfully, then a search for new matchings in step 316 is performed. New matchings, if any are found, are added to the queue. The processing flow then jumps to step 306.

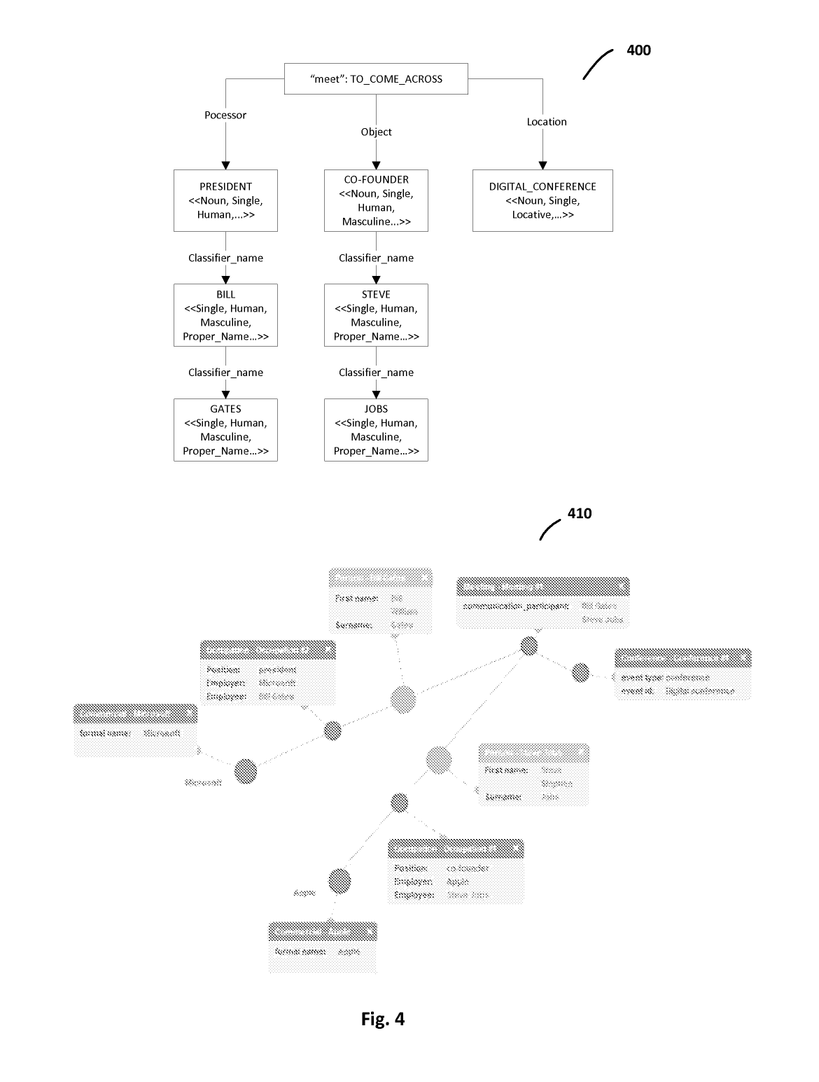

FIG. 4 shows an example of working with interpretation rules that convert the nodes of the semantic-syntactic tree [400] for the sentence “The president of Microsoft Bill Gates met Apple co-founder Steve Jobs at Digital Conference” into the interconnected information objects that make up a data graph [410]. Its vertices are information objects, e.g. facts or persons, as in the example being examined, while the edges are links between these objects, which correspond to relations from the ontology.

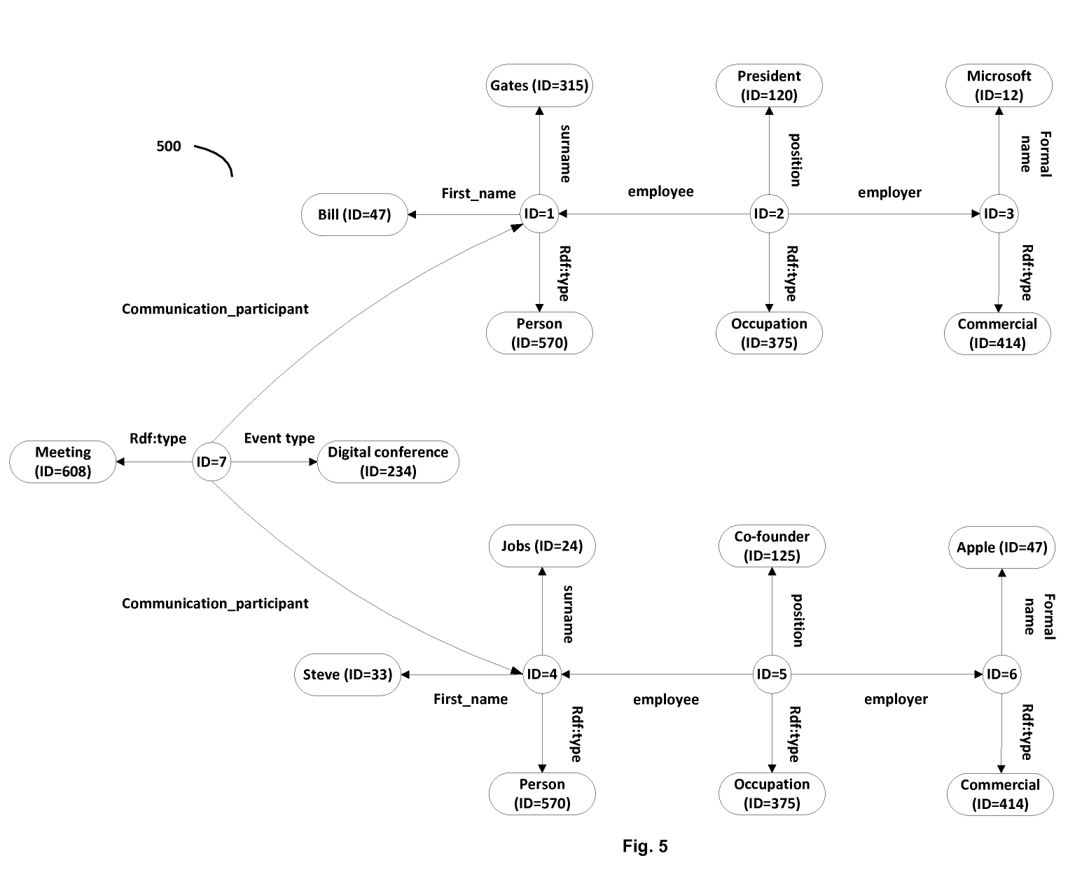

As stated above, the data graph is created during the information extraction process. FIG. 5 gives an example of an RDF graph [500] for the sentence “The president of Microsoft Bill Gates met Apple co-founder Steve Jobs at Digital Conference”, which is a variation of the representation of the information graph [410]. In accordance with the RDF concept, the data graph [410] is defined in the form of <subject, predicate, object> triplets. The subject corresponds to a graph vertex with an outgoing arc, the predicate is the arc itself, and the object corresponds to the vertex that the arc goes into. A triplet may specify an information object's non-object properties, i.e. its attributes, or object properties, i.e. its relations with other information objects. Let us consider the information object “Bill Gates”. Its type is “Person”. Then the triplet, which specifies that the information object is of type “Person”, assigns a non-object feature. In this example, the subject will be an information object identifier (ID=1), the predicate is the relation rdf:type, and the object is the type “Person”. The triplet looks like this: <ID=1, rdf:type, Person>. An example of an object feature could be the relation “Communication_participant”, which links the information objects “Bill Gates” and “Digital Conference”. The subject in this triplet would be the identifier for the information object “Digital Conference” (ID=7), the predicate is the relation “Communication_participant”, and the object is an information object's identifier (ID=1). The triplet looks like this: <ID=7, “Communication_participant”, ID=1>.

### Information Object Identification Rules (Global Identification)

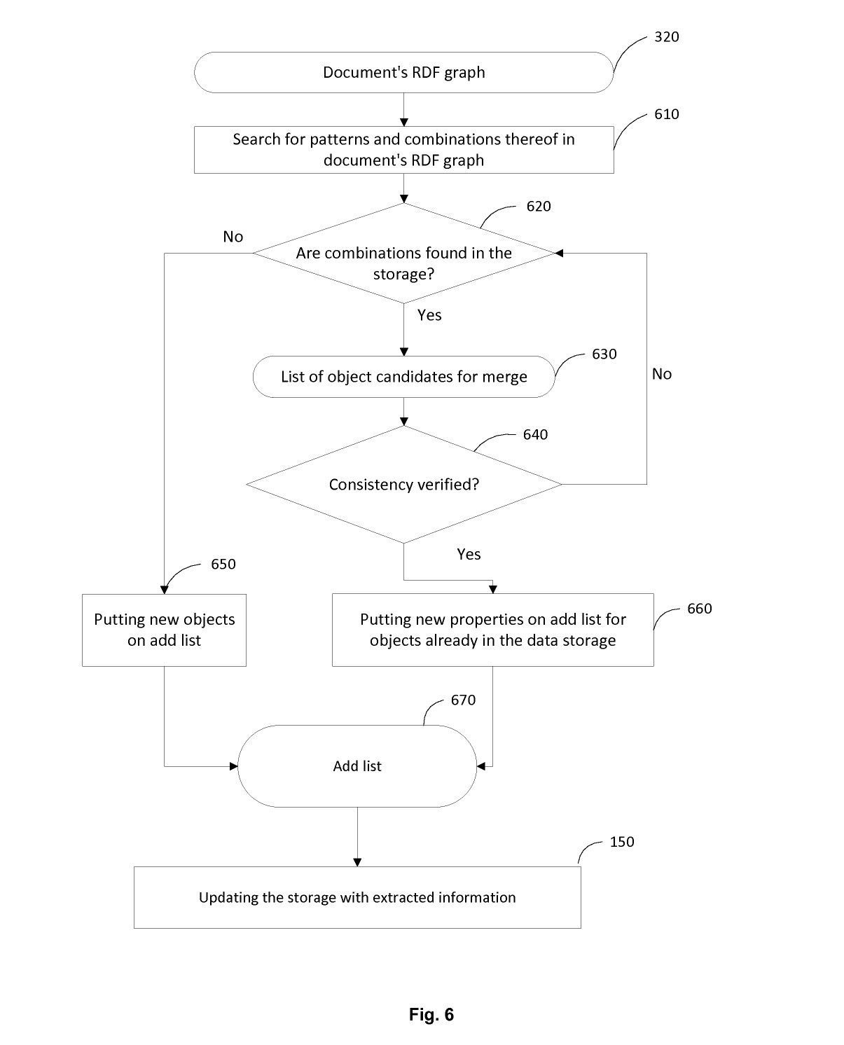

The final stage of the information extraction process is adding the data extracted from the text to the storage of extracted data. This is accomplished using a global identification process whose main steps are illustrated in FIG. 6. Global identification consists of associating the information objects from the document with topics already contained in the storage and merging identical objects. Because the information about the objects is represented as a tree, global identification may be alternatively formulated as a search for identical subgraphs in the RDF graphs of the document and the storage.

Global identification is performed using the identification rules mentioned previously. Identification rules differ significantly from interpretation rules in that identification rules only work with information objects, i.e. the nodes of semantic-syntactic trees cannot be used. Identification rules contain object conditions that are compared with information objects, and the identity of these information objects is inferred based on the result of the comparison.

Identification rules are otherwise known as combination of patterns. The SPAPQL language may be used to define patterns. A single pattern is responsible for only one of an information object's properties. Therefore, as a rule, rather than using individual patterns, reliable identification generally uses combinations of patterns. For example, the pattern combination <“First name”, “Surname”> is used to identify an information object with type “Person”. A combination may consist of an arbitrary number of patterns. A combination's value is an array of values for the patterns in the combination. All global identification patterns are contained in a special library. It is structured so that patterns designed to identify various objects in the real world are stored separately from each other.

FIG. 6 outlines an example of the global identification process. In the method being described, the global identification mechanism is a step-by-step process. In other words, identification is started sequentially for each new document added to the storage which contains the collection of documents that the identification process has already been run on.

A document's RDF graph [320] is the input for the global identification process (wherein we assume that object identification has been performed within some document and that all information objects in the graph are different). In the first stage of identification, a search is launched for known patterns and combinations of known patterns [610] in the document's RDF graph [320]. Then the storage [620] is also searched for the corresponding patterns and combinations. If patterns and combinations are found, then a list is generated of objects that are candidates for merger [630]. These objects are tested for consistency [640]. Consistency means that merging the information objects does not violate the cardinality of their relations (consistency with the ontology is not violated). If a pair fails the test, then the identification process returns to stage 620. If the consistency test [640] is passed, it means that the object from the document is already contained in the storage and all of the object's new properties extracted from the document are put on the add list [660]. During stage 620, if combinations found in the document's RDF graph do not have corresponding combinations in the storage, it means that the document contains new information objects and these new objects are put on add list [650]. In the last stage, the add list [670], which contains the new objects from the document, and the new properties already contained in the storage of objects are added to the storage of extracted data [150].

### Storage of Extracted Information

The storage of extracted data contains one or more RDF graph that represents all of the extracted information about real-world objects, and a collection of annotated document texts. The following types of structures are used to store the RDF graph: N-gram tables of identifiers (here N-gram means that the table has N columns) and a trie to store simple feature values.

### Storing Annotations

In one example aspect, in addition to the RDF graph itself, which is consistent with the OWL ontology, the storage may contain a collection of document texts and information about the extracted information objects' relationships with the source text (objects' annotations or “highlighting”).

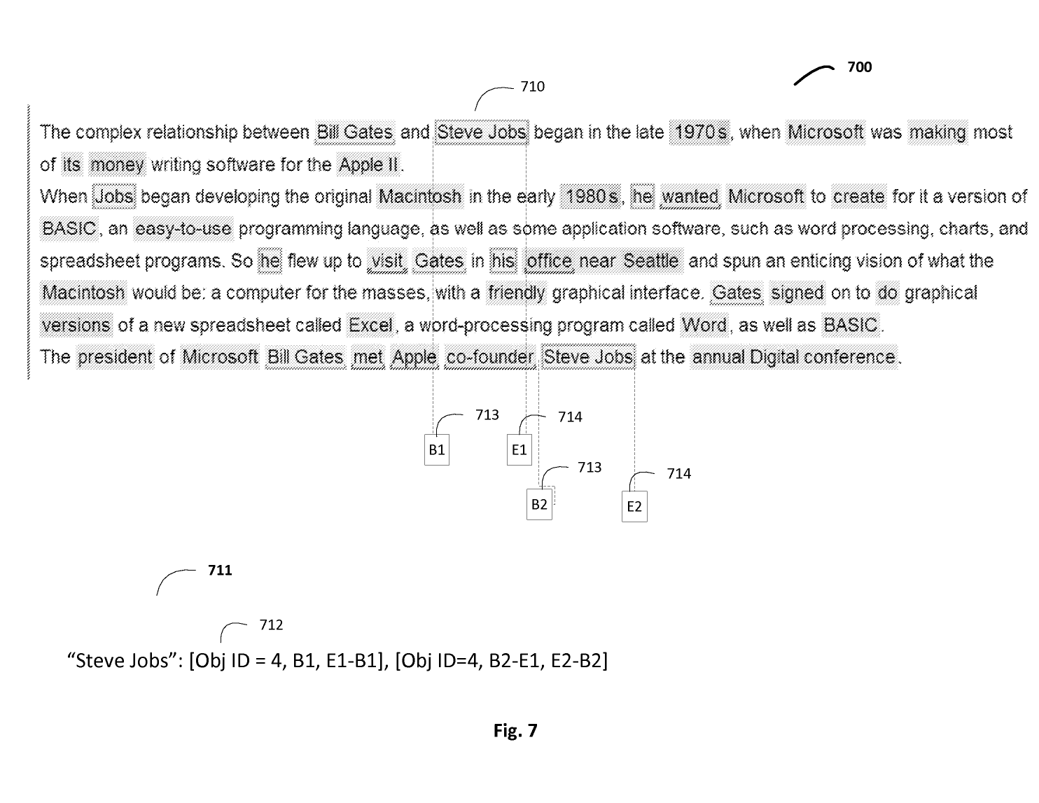

FIG. 7 provides an example of highlighting information objects [700] as well as an example of an annotation description [710]. Each annotation [711] contains three parameters: an object identifier [712], segment start index (character number) [713], and segment end index (character number) [714]. Object annotations are stored in the following format:
All annotations are sorted by increasing segment start index.
The number of annotations is recorded.
The following is sequentially recorded for each annotation:
a. Object identifier;
b. Distance between the current annotation's segment start and the next annotation's segment start. The segment start is recorded for the first annotation;
c. Annotation length.

This data is used to recover the segment start and end of all annotations as well as the identifiers of the objects bound to these annotations. Annotations are used to highlight all information objects in the text. Moreover, the highlight color corresponds to the information object's type (person, location, organization, etc.). The annotations may also be used to highlight all instances of the same information object in the text. For example, we encounter the information object “Bill Gates” in the text and we wish to see where else it occurs in the text. When the information object is clicked, the system highlights all of its occurrences in the document's text with a single color for convenient viewing.

### Organization of Identifier Tables

In one example aspect, three types of N-gram identifier tables may be used to search and access data in the storage: N-gram tables can contain N=2, 3, 4 columns. Tables with 2 columns store identifier doubles <x, y>; tables with 3 columns store identifier triples <x, y, z>; and table with 4 columns store identifier quads <x, y, z, o>. The individual elements x, y, z, o that make up the doubles <x, y>, triples <x, y, z>, and quads <x, y, z, o> may be unsigned integers.

Each table specifies an integer identity index that is used to search and access the extracted data. The lines of each table may be sorted lexicographically. For example, the triple <x1, y1, z1> is positioned in the triple table before the triple <x2, y2, z2> if x1<x2, or x1=x2 and y1<y2, or x1=x2 and y1=y2 and z1<z2. 2-gram and 4-gram tables are sorted similarly.

In one example aspect, the storage may contain a double index that facilitates searching of the storage by pairs <subject (s), document (d)>. For each subject, this index makes it possible to search and view a list of documents that contain them. A search of all documents containing a sought-after information object may be conducted efficiently due to the fact that all pairs <s, d> for the sought after s are arranged sequentially in the table.

In another example aspect, the storage may also contain one or more triple indexes that correspond to all possible permutations of columns in the table of triples <subject (s), predicate (p), object (o)>: <s, p, o>, <s, o, p>, <p, s, o>, <p, o, s>, <o, p, s>, <o, s, p>. Maintaining all possible permutations of columns makes it possible to quickly search with the index using different variations of the search query. For example, if all information about a specific information object s must be found, the search would be conducted using the <s, p, o> index; if all persons with the “Ivan” (i.e. with a specific object value o) must be found, then the search would be conducted using the <o, p, s> index; and if we are interested in information objects with a specific attribute (i.e. with predicate value p), then the search would be conducted using the <p, s, o> index, and so forth.

In another example aspect, the storage may also contain a quad index <document (d), subject (s), predicate (p), object (o)>. This table contains for each document, a list of triplets extracted from that document.

Each of these index tables may contain identifiers of the concepts, predicates, information objects, documents, and simple feature values.

Concept- and predicate (attribute and relation) identifiers are determined when defining a specific domain.

An information object's identifier is assigned when a new vertex is added to the storage's RDF graph (i.e. it is the information object's index number in the storage).

A document's identifier is also assigned when the document is added to the storage.

Simple feature identifiers are identifiers of strings and numbers. String identifiers are computed using a special data structure called a trie. With a trie, a string may be used to quickly get its identifier and search for triplets where it is object's value. Number identifiers are also computed and stored using a trie.

Depending on the type of predicate p, the element o may take different values. For example, if a specific type of information object (pertaining to a specific concept in the ontology) is a relation value, then o is the value of the information object's identifier. If the relation is rdf:type (assigning o to a concept), then o is the value of the concept identifier. If the relation type is a simple Boolean type, then the triple's o value will be 0 or 1. If the relation type is a simple string type, then the value of o will be the string identifier in the storage of strings. If the relation type is a simple number type, then the value will be the identifier of a string containing a string representation of the number.

The range of values of the elements s, p, o of a triplet are divided into the following non-intersecting subranges:
Concept identifiers;
Identifiers of predicates representing non-object properties;
Identifiers of predicates representing object properties;
Information object identifiers.

A type may be determined using the range of the triplet's element values. This is helpful, for example, when searching for all of a specific information object's relationships with other information objects related in the real world. The search in this case will be conducted using the <s, p, o> index. The system will find all index entries where subject s is the specified information object's identifier, and predicate p is identifiers that fall within the range of predicates representing object properties. In the search results, objects o will be identifiers of information objects associated with the specified object.

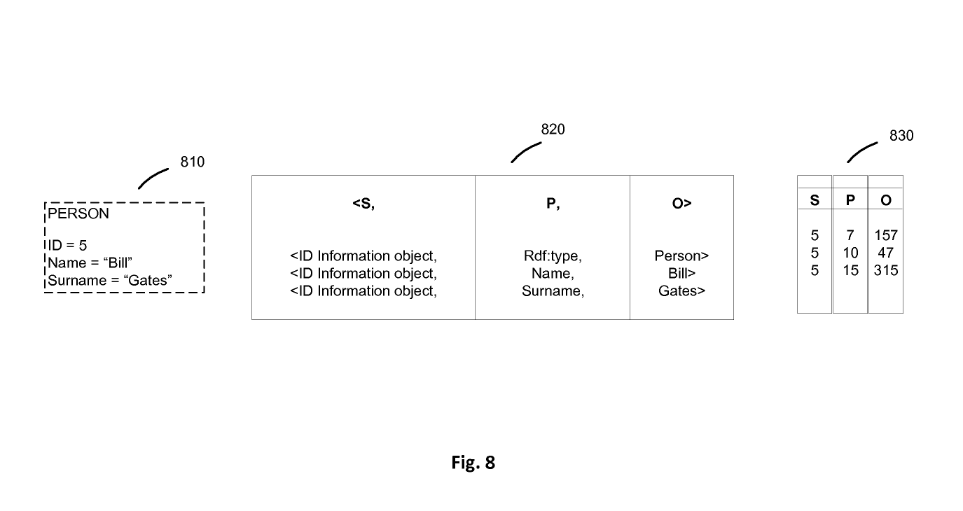

Let us return to FIG. 5 and consider the example of the information object “Bill Gates”, which is of type “Person”. Suppose that when the information object [510] was added to the storage that it was assigned the identifier 5 (ID=5). The information object's type in RDF is specified by the rdf:type relation. Let its identifier in the storage be 7 (ID=7). Suppose that the concept “Person” was assigned the value 570, i.e. ID=570, when the domain was defined. Moreover, the “Person” concept possesses attributes <name> and <surname>, which were assigned ID=10 and ID=15, respectively, when the domain was defined. In the information object being considered, the attributes <name> and <surname> have the values “Bill” and “Gates”. These are strings. Let the string “Bill” have ID=47 and “Gates” have ID=315. FIG. 8 presents an example of the information object [810], which is described by the set of triples in 820. The set of integer triples comprises table 830. In table 830 the index is sorted by parameter s, but, as stated above, the storage contains triple indices with all possible permutations of columns.

Search operations with the N-gram tables being used in the storage include: searching for a string in the index, searching for a string with unknown parameters, moving to the next string, moving to the next string with a more refined search, advanced search.

In various aspects, selection of the search index may be based on the type of searched objects and its properties. For example, if one searches the data storage for objects related in the real world to the object extracted from a text document, the search may be performed for triplets in the index that has in the first place parameter responsible for establishing relations between objects—that is, predicate parameter p. That search may be conducted in the index of triplets <p, s, o> or <p, o, s>. In another example, if the search query includes a string value “Ivan”, the search may be carried out in the index, which in the first place has object parameter o. This search may be conducted in the index of triples <o, p, s> or <o, s, p>. Likewise, if the search query asks for all information objects related to subject s in a document d, then double index <d, s> or quad index <d, s, *, *> may be used to search for desired information.

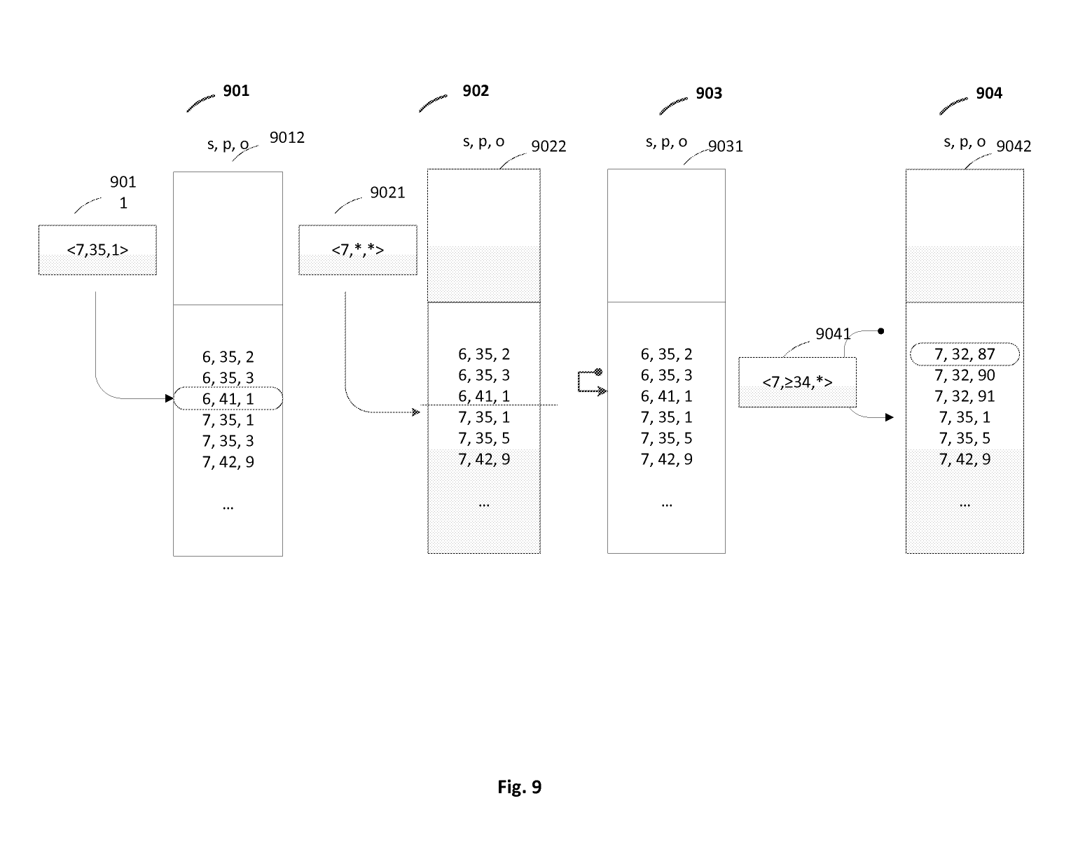

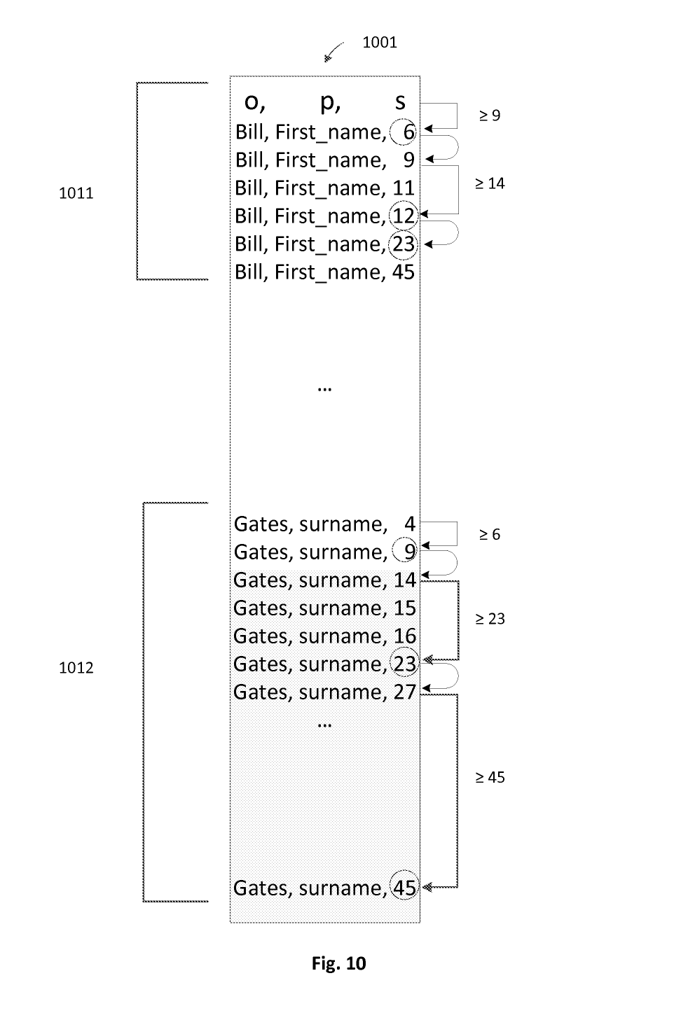

FIG. 9 and FIG. 10 schematically depict different types of search operations. Searching for a string [901] in the index [9012] is an operation that satisfies a query [9011] containing all three parameters <s, p, o>. For example, we need to check the storage to see whether the person “Bill Gates” participated in the annual “Digital Conference”. Let the information object “Digital Conference” have the identifier ID=7, the person “Bill Gates” have the identifier ID=1, and the relation “Communication participant” have the identifier ID=35. To check whether Bill Gates participated in the conference, it is necessary and sufficient to check whether the triple <7, 35, 1> is in the <s, p, o> table. In this example, s=7, p=35, and o=1.

In another example aspect, it is also possible to search using one or two of the three parameters. This is known as a search with unknown parameters [902]. For example, we must find all of the properties of the information object “Digital Conference” (ID=7). The search will be conducted using the parameter s. In this case the query [9021] will have the form <7, *, *>. The search will be conducted in that portion of the index [9022] that contains triples with identifier ID=7. The result of this search operation will be all triples where s=7.

Another type of search operation using the index is moving from a string [903] in the index [9031] to the string that follows lexicographically. For example, searching for the string that follows <6, 35, 3> will return <6, 41, 1>.

Another form of search operation using the index is moving from a string to one of the next strings using a refined search [904]. Suppose we are searching index 9042 and the search iterator's current position is <7, 32, 87>. Suppose we now want to find the next string where the identifier s is 7 and the identifier p is no less than 34. The refined query <7, 34, *>[9041] immediately “jumps” from the current position to the first string containing the required parameters. A refined search is useful when processing complex queries, it reduces the number of iterations, and thus accelerates the search process.

An example of a complex search is given in FIG. 10.

This type of search may be used, for example, to find identical information objects (i.e., two information objects related to the same object in the real world) in sorted lists. In our example, lists [1011] and [1012] are different parts of the same index [1001]. Suppose, for example, we must find information objects of type “Person”, which possess both of the following features: surname “Gates” and first name “Bill”. The index [1001] contains triplets sorted by parameters <o, p, s>, where o is the string identifiers of the first name “Bill” and the surname “Gates”, p is the attribute identifiers for “First_name” and “surname”, and s is information object identifiers. Because the strings are sorted lexicographically, we compare them using parameter s. To start we perform two searches with an unknown o in order to determine the starting positions of two iterators. The first iterator will move along information objects with the first name “Bill”. Its initial position is set by the search query <47, 10, *>. The second iterator will move along information objects with the surname “Gates”. Its initial position is set by the search query <315, 15, *>. We compare the values of the identifiers of the first information objects that satisfy the queries. In our case, these are 6 and 4. We move the smaller iterator (list 1012) with a refined query to a value no less than 6. It stops on the value 9. The new values are 6 and 9, respectively. Then we again move the smaller iterator (list 1011) with a refined query to a value no less than 9. It stops on the value 9. The values match. Consequently, the information object whose identifier is 9 satisfies the search query. Then we move the iterators again using a refined search until the next time the identifiers match. Specifically: we more iterators for lists 1010 and 1012 to the values after 9; these are 11 and 14. Then we move the smaller iterator using a refined search to a value greater than or equal to 14. The iterator stops on 23. We move the iterator for list 1012 using a refined search to a value greater than or equal to 23. The iterator stops on 23. We have our second match. We follow a similar procedure to find the intersection of information objects with identifier 45. This “jumping” about the lists avoids reading all the values of s's identifier in each of the lists. The time required for each “jump” is comparable to the time required to move to the next string in the list. As a result, the time required for this complex search is substantially reduced. This type of search is called a ZigZag Join.

Operations that change an N-gram table include: inserting a string and deleting a string.

In one example aspect, row insertion operations are performed when information storage is updated by adding a new document to the information storage. The global identification process determines whether the information objects encountered in documents are contained in the storage. There are two possible cases: the storage does not contain an information object encountered in a document being added, or the storage already contains the information object encountered in the document being added. In the first case, the information object will be assigned its own identifier s and all of the new object's properties will be added to the SPO, SOP, POS, PSO, OPS, and OSP indices; likewise, the new information object's properties will be added to the DSPO index, and a new string will be added to the SD index. In the second case, the information object's identifier s is already known and only the information object's new properties that are not already in the storage will be added to the storage. Accordingly, these new properties will be added to all triples and the quad index, while a new string will be added to the double index. For example, suppose the storage contains information about the persons “Bill Gates” and “Steve Jobs”, but that there is no information about any such event as the “Digital Conference”. The fact of Bill Gates meeting Steve Jobs at the Digital Conference is encountered in the document being added and a new information object—the fact of the meeting and its attributes and relations are added to the storage. An example of adding new properties to information objects already contained in the storage is adding the patronymic to the “Person” type.

Row deletion operations are used when deleting a document from the storage. This involves purging information about objects from the document being deleted.

In one example aspect, a B-tree may be used to maintain the index. B-trees are built for each index. Its vertices are the strings in the lexicographically sorted table. Using this data structure makes it possible to maintain an index on a hard disk and efficiently perform search operations and index modification operations.

### Storing Information about a Single Document

In one example aspect, the following information may be stored separately for each document:
Document name.
Document URL.
Hash of document in order to quickly check whether a document is present based on content.
Annotations of objects mentioned in the document.

In one example aspect, the actual objects alluded to and their properties may be stored in the indices <s, d>, which is used to retrieve documents in which an object is mentioned, and <d, s, p, o>, which is used to retrieve all of a document's triplets.

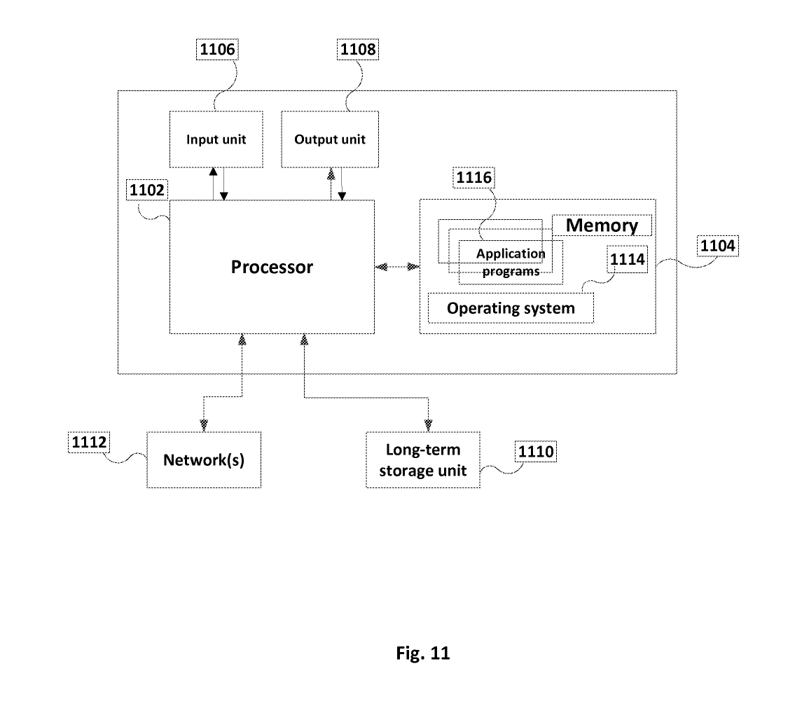

FIG. 11 shows a possible example of a computer platform [1100] that may be used to implement the present invention, as described above. The computer platform [1100] includes at least one processor [1102] connected to a memory [1104]. The processor [1102] may be one or more processors, may contain one, two, or more computer cores, or may be a chip or other device capable of performing computations. The memory [1104] may be random-access memory (RAM) and may also contain any other types or kinds of memory, particularly non-volatile memory devices (such as flash drives) or long-term storage devices such as hard drives, etc. Additionally, it may be assumed that memory [1104] includes data storage hardware that is physically located elsewhere in the computer platform [1100], e.g. cache memory in the processor [1102] that is used as virtual memory and stored on an external or internal permanent memory device [1110].

The computer platform [1100] also usually has a certain number of input and output ports to transfer information out and receive information. For interaction with a user, the computer platform [1100] may include one or more input devices (such as a keyboard, a mouse, a scanner, etc.) and a display device [1108] (such as a liquid crystal display or special indicators). The computer platform [1100] may also have one or more permanent storage devices [1110] such as an optical disk drive (CD, DVD, or other), a hard disk, or a tape drive. In addition, the computer platform [1100] may have an interface with one or more networks [1112] that provide connections with other networks and computer equipment. In particular, this may be a local area network (LAN) or wireless (Wi-Fi) network, and may or may not be connected to the World Wide Web (Internet). It is understood that the computer platform [1100] includes appropriate analog and/or digital interfaces between the processor [1102] and each of the components [1104, 1106, 1108, 1110 and 1112].

The computer platform [1100] is managed by the operating system [1114] and includes various applications, components, programs, objects, modules, and other items, which are indicated by a consolidated number [1116].

There are numerous advantages of the disclosed systems, methods and computer program products for storing and searching extracted information. For example, using integer indices facilitates efficient storage and rapid searching of storage of extracted data. Triple indices of all permutations may be used to quickly search using any query of the form <*, p, *>. The double index <s, d> may be used to quickly access documents that contain an object. Quickly moving using refined searches makes it possible to efficiently execute complex search queries. The quad index may be used to extract information about information objects contained in a document and their relationships within the document. Annotations make it possible to keep track of occurrences of a specific information object in a collection of texts.

The programs used to implement the methods corresponding to this invention may be part of an operating system or may be a standalone application, component, program, dynamic library, module, script, or a combination thereof.

All the routine operations in the use of the implementations can be executed by the operating system or separate applications, components, programs, objects, modules or sequential instructions, generically termed “computer programs”. The computer programs usually constitute a series of instructions stored in a different data storage and memory devices on the computer. After reading and executing the instructions, the processors perform the operations needed to initialize the elements of the described implementation. Several variants of implementations have been described in the context of existing computers and computer systems. The specialists in the field will properly judge the possibilities of disseminating certain modifications in the form of various program products on any given types of information media. Examples of such media are power-dependent and power-independent memory devices, such as diskettes and other removable disks, hard disks, optical disks (such as CD-ROM, DVD, flash disks) and many others. Such a program package can be downloaded via the Internet.

In the specification presented above, many specific details have been presented solely for explanation. It is obvious to the specialists in this field that these specific details are merely examples. In other cases, structures and devices have been shown only in the form of a block diagram to avoid ambiguity of interpretations.

In various aspects, the systems and methods described herein may be implemented in hardware, software, firmware, or any combination thereof. If implemented in software, the methods may be stored as instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all of the routine features of the aspects are disclosed herein. It will be appreciated that in the development of any actual implementation of the present disclosure, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

1. A computer-implemented method for storing in a computer system, searching and updating data extracted from text documents, the method comprising:
extracting at least one first information object from a text document;
generating one or more subject-predicate-object triplets for the first information object;
accessing a storage of extracted data that contains a RDF graph comprising a plurality of subject-predicate-object triplets for a plurality of different information objects extracted from different text documents;
searching the storage of extracted data for a second information object related to the same object in real world as the first information object, wherein two information objects are related when said two information objects have at least the subject parameter in common, and wherein searching includes selecting and searching at least one of three types of identifier tables containing one of a double, a triple and a quad search indices, wherein each search index is based on at least two parameters selected from a subject, a predicate, an object and a document;
when at least one second information object related to the same object in real world as the first information object is found, updating the storage of extracted data by adding the at least one subject-predicate-object triplet of the first information object to the RDF graph and updating at least one of the three types of indexes tables.

2. The method of claim 1, wherein selection of a search index is based on type of searched object and its features.

3. The method of claim 1, wherein the lines of each identifier table are sorted lexicographically.

4. The method of claim 1, wherein the double index includes a table with two columns that stores subject (s) and document (d) identifiers.

5. The method of claim 1, wherein the triple index includes one or more tables with three columns that store one or more permutations of subject (s), predicate (p) and object (o) identifiers.

6. The method of claim 1, wherein the quad index includes a table with four columns that stores document (d), subject (s), predicate (p) and object (o) identifiers.

7. The method of claim 1, wherein when at least one second information object related to the same object in real world as the first information object is found in the storage of extracted data, updating the storage further comprises:
determining subject identifier of the second information object in the storage; and
adding one or more new features of the first information object to the features of the subject identifier of the second information object in the storage.

8. The method of claim 1, wherein when at least one second information object related to the same object in real world as the first information object is not found in the storage of extracted data, updating the storage further comprises:
assigning a new subject identifier to the first information object; and
adding one or more new features of the first information object to the three types of identifier tables.

9. The method of claim 1 further comprising
generating an annotation for the first information object that indicates a relationship of the annotated first information object to the text document;
marking in the text document the annotated first information object; and
storing in the storage of extracted data the annotation and at least a portion of the text document containing the annotated first information object.

10. A system for storing, searching and updating extracted data, the system comprising:
a storage of extracted data containing a RDF graph comprising a plurality of subject-predicate-object triplets for a plurality of different information objects;
a hardware processor coupled to the storage, the processor being configured to:
extract at least one first information object from a text document;
generate one or more subject-predicate-object triplets for the first information object;
search the storage of extracted data for a second information object related to the same object in real world as the first information object, wherein two information objects are related when said two information objects have at least the subject parameter in common, and wherein searching includes selecting and searching at least one of three types of N-gram identifier tables containing one of a double, a triple and a quad search indices, wherein each search index is based on at least two parameters selected from a subject, a predicate, an object and a document;
when at least one second information object related to the same object in real world as the first information object is found, update the storage of extracted data by adding the at least one subject-predicate-object triplet of the first information object to the RDF graph and updating at least one of the three types of indexes tables.

11. The system of claim 10, wherein selection of a search index is based on the type of searched object and its features.

12. The system of claim 10, wherein the lines of each identifier table are sorted lexicographically.

13. The system of claim 10, wherein the double index includes a table with two columns that stores subject (s) and document (d) identifiers.

14. The system of claim 10, wherein the triple index includes one or more tables with three columns that store one or more permutations of subject (s), predicate (p) and object (o) identifiers.

15. The system of claim 10, wherein the quad index includes a table with four columns that stores document (d), subject (s), predicate (p) and object (o) identifiers.

16. The system of claim 10, wherein when at least one second information object related to the same object in real world as the first information object is found in the storage of extracted data, updating the storage of extracted data further comprises:
determining subject identifier of a second information object in the storage; and
adding one or more new features of the first information object to the features of the subject identifier of a second information object in the storage.

17. The system of claim 10, wherein when at least one second information object related to the same object in real world as the first information object is not found in the storage of extracted data, updating the storage further comprises:
generating an annotation for the first information object that indicates a relationship of the annotated first information object to the text document; and
storing in the storage of extracted data the annotation and at least a portion of the text document containing the annotated first information object.

18. The system of claim 10, wherein the processor further configured to:
generate an annotation for the first information object that indicates a relationship of the annotated first information object to the text document;
mark in the text document the annotated first information object; and
stored in the storage of extracted data the annotation and at least a portion of the text document containing the annotated first information object.

19. A computer program product stored on a non-transitory computer-readable storage medium, the computer program product comprising computer-executable instructions for storing, searching and updating extracted data, comprising instructions for:
extracting at least one first information object from a text document;
generating one or more subject-predicate-object triplets for the first information object;
accessing a storage of extracted data that contains a RDF graph comprising a plurality of subject-predicate-object triplets for a plurality of different information objects;
searching the storage of extracted data for a second information object related to the same object in real world as the first information object, wherein two information objects are related when said two information objects have at least the subject parameter in common, and wherein searching includes selecting and searching at least one of three types of identifier tables containing one of a double, a triple and a quad search indices, wherein each search index is based on at least two parameters selected from a subject, a predicate, an object and a document;
when at least one second information object related to the same object in real world as the first information object is found, updating the storage of extracted data by adding the at least one subject-predicate-object triplet of the first information object to the RDF graph and updating at least one of the three types of indexes tables.

20. The computer program product of claim 19, wherein selection of a search index is based on the type of searched extracted data.

21. The computer program product of claim 19, wherein the lines of each identifier table are sorted lexicographically.

22. The computer program product of claim 19, wherein the double index includes a table with two columns that stores object (o) and document (d) identifiers.

23. The computer program product of claim 19, wherein the triple index includes one or more tables with three columns that store one or more permutations of subject (s), predicate (p) and object (o) identifiers.

24. The computer program product of claim 19, wherein the quad index includes a table with four columns that stores document (d), subject (s), predicate (p) and object (o) identifiers.

25. The computer program product of claim 19, wherein adding the at least one subject-predicate-object triplet of the first information object to the master RDF graph comprises assigning to the first information object a unique global identifier in the storage of extracted data.

26. The computer program product of claim 19 further comprising instructions for:
generating an annotation for the first information object that indicates a relationship of the annotated first information object to the text document;
marking in the text document the annotated first information object; and
storing in the storage of extracted data the annotation and at least a portion of the text document containing the annotated first information object.
